(19) United States
(12) Patent Application Publication
(10) Pub. No.: US 2015/0230392 A1
(43) Pub. Date: Aug. 20, 2015

(54) Wheel Gauge Arm

(71) Applicants: Brian Schafer, Culbertson, NE (US); Clint Schafer, Culbertson, NE (US)

(72) Inventors: Brian Schafer, Culbertson, NE (US); Clint Schafer, Culbertson, NE (US)

(21) Appl. No.: 14/626,229

(22) Filed: Feb. 19, 2015

Related U.S. Application Data
(60) Provisional application No. 61/941,813, filed on Feb. 19, 2014.

(51) Int. Cl. A01B 76/00

(52) U.S. Cl. CPC A01B 76/00

(57) ABSTRACT

Gauge wheels control the depth at which seeds are placed during planting operations. Planter gauge wheels are mounted on gauge wheel arms which become dusted with soil during normal operation. An improved gauge wheel arm described herein includes first and second hubs extending from either end of a shaft. Each hub forms a cylindrical body between first and second faces. The first hub has a central channel through the cylindrical body, and a bearing is press-fit within the central channel. A retaining ring is fitted over the bearing, within an interior groove formed proximate the first face of the central channel, to retain the bearing within the central channel. The improved gauge wheel arm described herein reduces build-up of dirt and frictional wear, thus increasing both the life span of the arm and its associated parts, and decreasing time spent greasing and adjusting gauge wheel arms.

### RELATED APPLICATIONS

This application claims priority to U.S. Provisional Application Ser. No. 61/941,813 filed Feb. 19, 2014. The aforementioned application is incorporated by reference in its entirety.

### BACKGROUND

Gauge wheels control the depth at which seeds are placed during planting operations, and may also serve as temporary soil storage as a planter works over a field. Planter gauge wheels are mounted on gauge wheel arms which, due to their proximity to the soil and the gauge wheels, are dusted with soil during normal operation of the planter.

Conventional gauge wheel arms are not compatible with soil contact, and therefore require much greasing and adjusting in order to maintain smooth operation during planting.

### SUMMARY

In one embodiment, an improved gauge wheel arm includes first and second hubs extending from either end of a shaft. Each hub forms a cylindrical body between first and second faces. The first hub has a central channel through the cylindrical body. A bearing is press-fit within the central channel. A retaining ring is fitted over the bearing, within an interior groove formed proximate the first face of the central channel, to retain the bearing within the central channel.

In an embodiment, a gauge wheel arm includes a cylindrical hub extending from one end of the arm. The cylindrical hub has a first face, a second face, and a central channel therethrough. The second face forms a lip around the circumference of the central channel, thereby providing an opening of smaller diameter than the central channel diameter. A sealed bearing is press-fit inside the central channel and the sealed bearing is held in place against the lip of the second face. A retaining ring is configured to retain the sealed bearing inside the first face, thereby securing the sealed bearing within the central channel.

### BRIEF DESCRIPTION OF THE DRAWINGS

FIG. 1 is a side view of an improved gauge wheel arm, according to an embodiment.

FIG. 2 is an enlarged, partial perspective view of a first hub of the improved gauge wheel arm of FIG. 1.

FIG. 3 is an enlarged, partial perspective view of the first hub of FIGS. 1 and 2, showing a press-fit bearing.

FIG. 4 is an enlarged partial view of the first hub and bearing of FIG. 3.

FIG. 5 is an enlarged partial perspective view of the first hub and bearing of FIGS. 3-4, showing an additional retaining ring.

FIG. 6 separately shows the hub, bearing and retaining ring of FIG. 5.

FIG. 7 separately shows the hub, bearing and retaining ring of FIGS. 5 and 6.

FIG. 8 is a schematic view of another improved wheel gauge arm, according to an embodiment.

FIGS. 9 and 10 show additional detail of the arm of FIG. 8.

FIG. 11 is a schematic view of another improved wheel gauge arm, according to an embodiment.

FIG. 12 is a schematic view of another improved wheel gauge arm, according to an embodiment.

FIG. 13 is a schematic view of another improved wheel gauge arm attached to a gauge wheel, according to an embodiment.

### DETAILED DESCRIPTION

Conventional gauge wheel arms require greasing, which leads to collection of dirt within functional wheel arm parts. Build-up of dirt creates friction, which leads to wear on the arm, the arm bushing, and even the gauge wheel itself.

The improved gauge wheel arm described herein addresses the problems of build-up and frictional wear, thus increasing both the life span of the arm and associated parts, and reducing the amount of time previously spent greasing and adjusting gauge wheel arms.

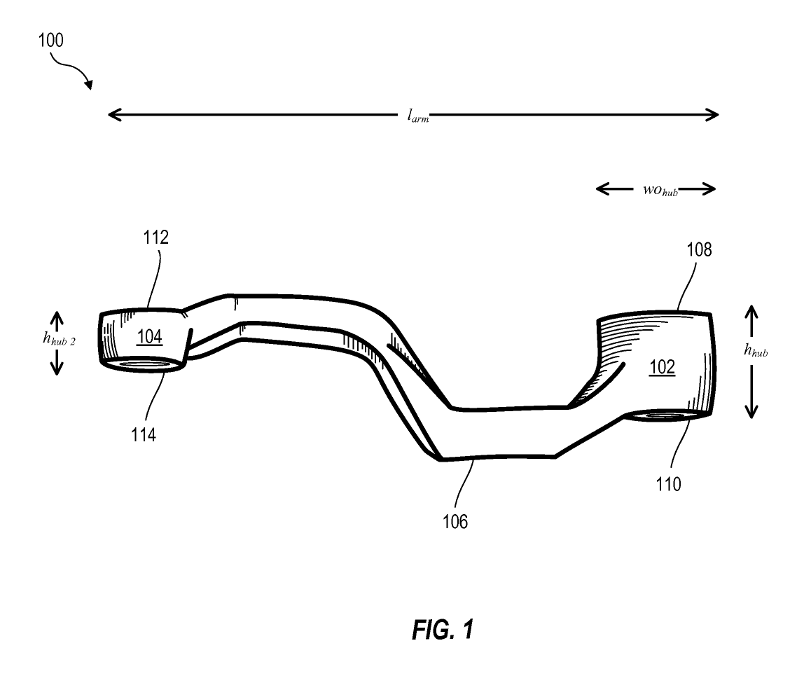

FIG. 1 shows a gauge wheel arm 100 having opposing hubs 102, 104 extending from either end of a shaft 106. In one embodiment, gauge wheel arm 100 has a length l_{ARM} of about 11 inches to 11¼ inches, and hub 102 has an outer width/diameter wo_{hub} of about 2 inches and a height h_{hub} of about 2 inches. In one aspect, l_{ARM} is 11.375 inches, wo_{hub} is 2.054 inches and h_{hub} is 1.922 inches. Gauge wheel arm 100 is made for example of metal.

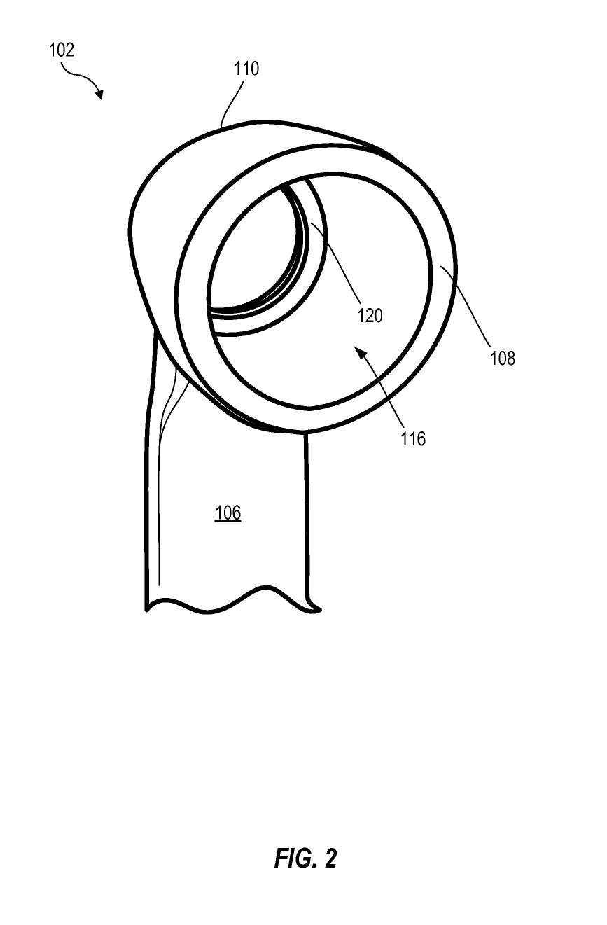

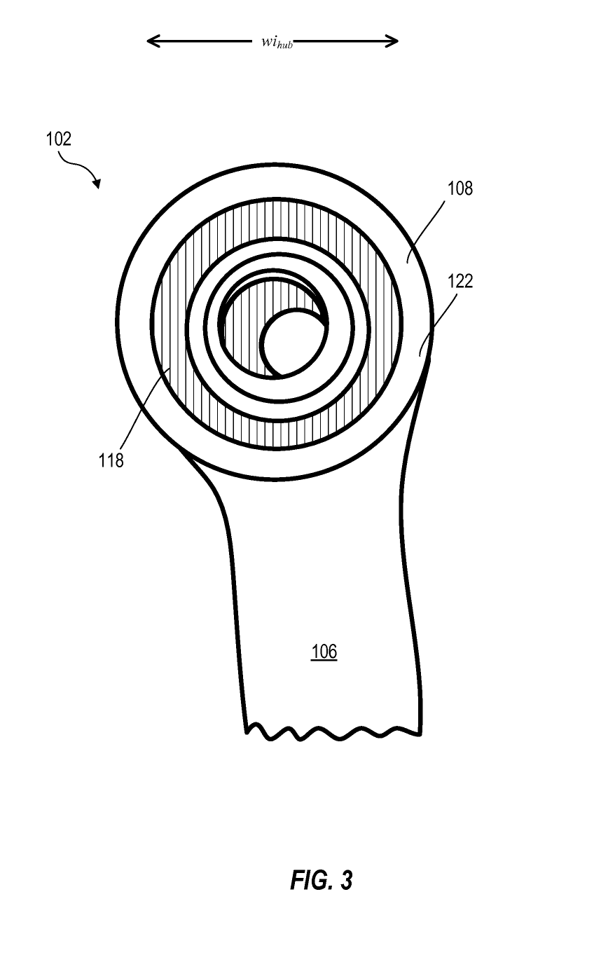

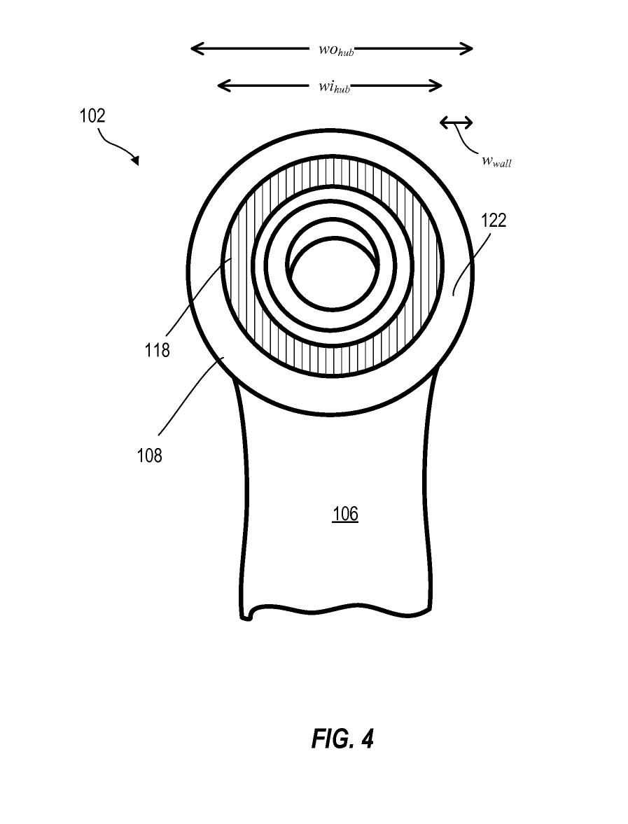

Hub 102 includes a roughly cylindrical body between a first face 108 and an opposing second face 110. Hub 104 has a roughly cylindrical body between a first face 112 and an opposing second face 114. As shown in FIG. 2, hub 102 forms a central channel 116 therethrough. Central channel 116 is sized and shaped to fit a common bearing 118 (FIGS. 3-4), which is for example press-fit into central channel 116. In one embodiment, bearing 118 is a sealed bearing, and thus protects against dirt and debris entering the bearing and prevents arm 100 from freezing up due to accumulated dirt. Arm 100 is thereby able to move more smoothly and consistently as compared to conventional gauge wheel arms, and thus lends to a more uniform planting depth. In addition, sealed bearing 118 eliminates the need to grease and adjust gauge wheel arm 100 (as compared with conventional arms, which require daily greasing and adjustment during planting), thereby eliminating mess and increasing planting efficiency by allowing a user to spend time planting, rather than attending to the gauge wheel arm.

In addition, precision-pressing bearing 118 into central channel 116 may eliminate “play” (i.e., slight movement) of bushings in conventional wheel gauge arms, thus beneficially preventing rubbing and wear between gauge wheels and adjacent discs. As shown in FIG. 2, central channel 116 may be machined or otherwise made smooth and featureless. Optionally, central channel 116 may include features to facilitate placement and retention of bearing 118 (i.e., directional, holding or lock-and-key features). In one aspect, a terminal lip 120 extends from proximate second face 110, to prevent bearing 118 from being pressed or slipping out of central channel 116. A bushing may replace or be used in conjunction with lip 120 for retention purposes.

FIGS. 3 and 4 show bearing 118 within central channel 116. Hub 102/central channel 116 has an inner width wi_{hub} of about 1¼ to 1¾ inches. Hub 102 has an outer width wo_{hub} of about 2 to 2¼ inches. A circumferential outer wall 122 of hub 102 has a width w_{wall} of about ½ inch. In one aspect wi_{hub} is 1.577 inches, wo_{hub} is 2.054 inches, and w_{wall} is 0.477 inches. In another aspect, wi_{hub} is 1.577 inches, wo_{hub} is about 2.179 inches, and w_{wall} is about 0.602 inches.

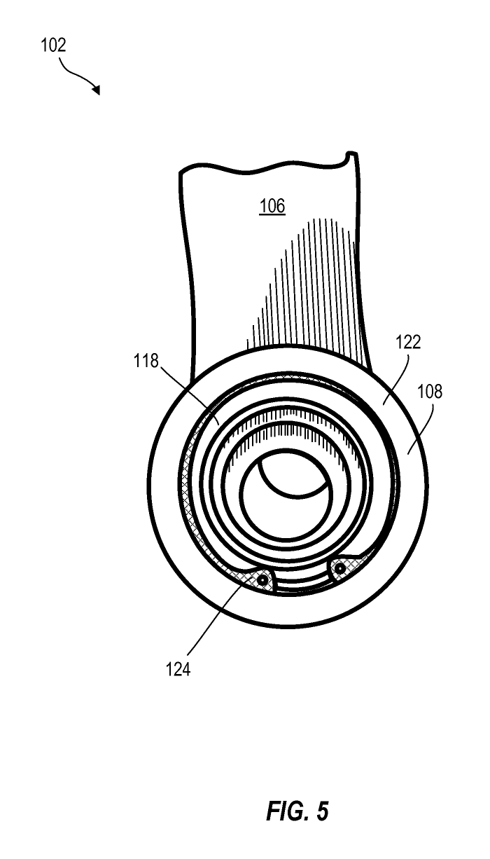

As shown in FIG. 5, a retaining ring 124 may be placed over/in front of bearing 118 to hold bearing 118 inside first face 108 within central channel 116. First face 108 may therefore form a lip extending from central channel 116, and/or central channel 116 may include an interior groove or other retaining feature(s) to retain ring 124 within central channel 116 and in front of bearing 118. Retaining ring 124 is for example made of a metal having sufficient resiliency to allow a user to pinch its ends together to reduce the circumference of the ring and allow it to be placed within central channel 116, and/or to spread the ring to fit firmly within central channel 116.

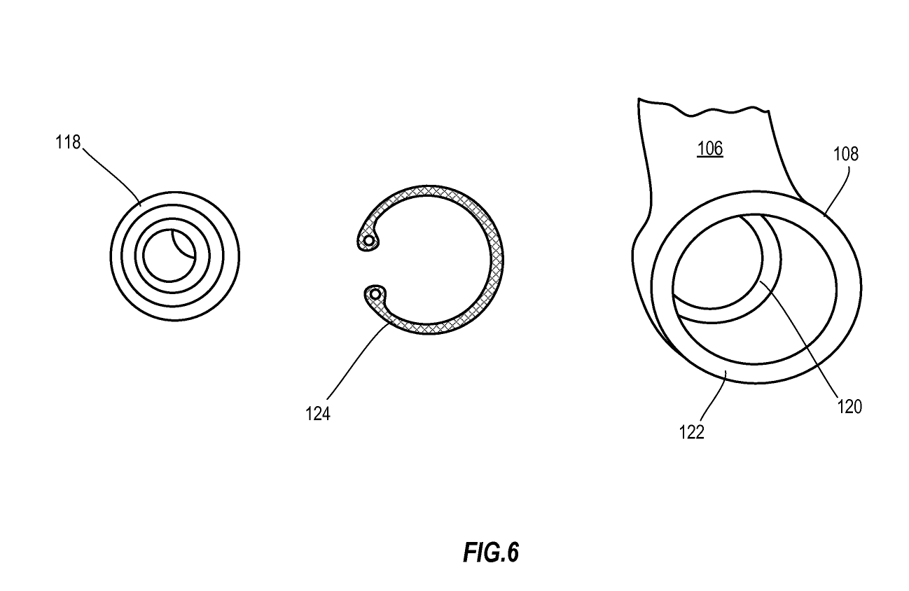

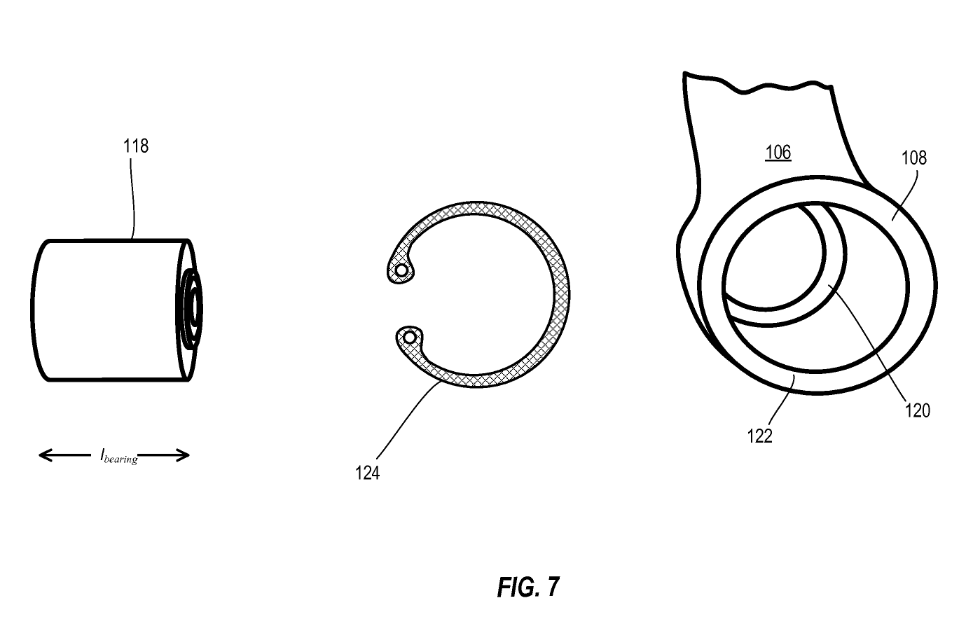

FIGS. 6 and 7 are exploded views showing head 102, retaining ring 124 and bearing 118. In one aspect, gauge wheel arm 100 is assembled by press-fitting bearing 118 into central channel 116 until an end of bearing 118 abuts lip 120 or a bushing used in addition to or in place of lip 120. Retaining ring 124 is fitted over bearing 118 into a terminal groove proximate first face 108, to hold bearing 118 in place within central channel 116. Bearing 118 has a length l_{bearing} of about 1½ to 1¾ inches and a width w_{bearing} of about 1¼ to 1⅔ inches. In one aspect, l_{bearing} is 1.729 inches and w_{bearing} is 1.568 inches.

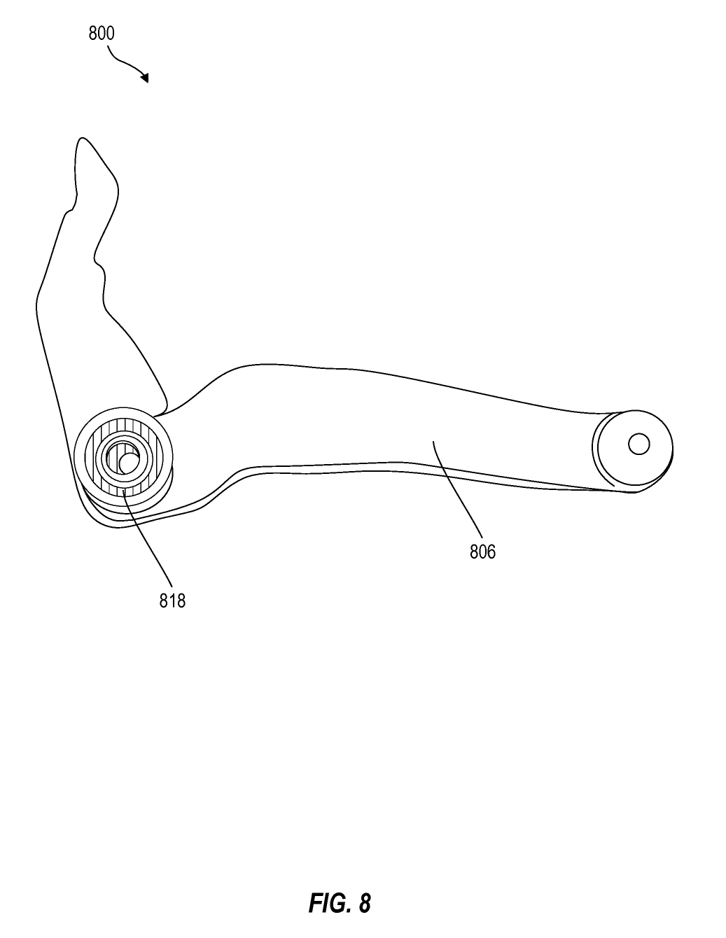

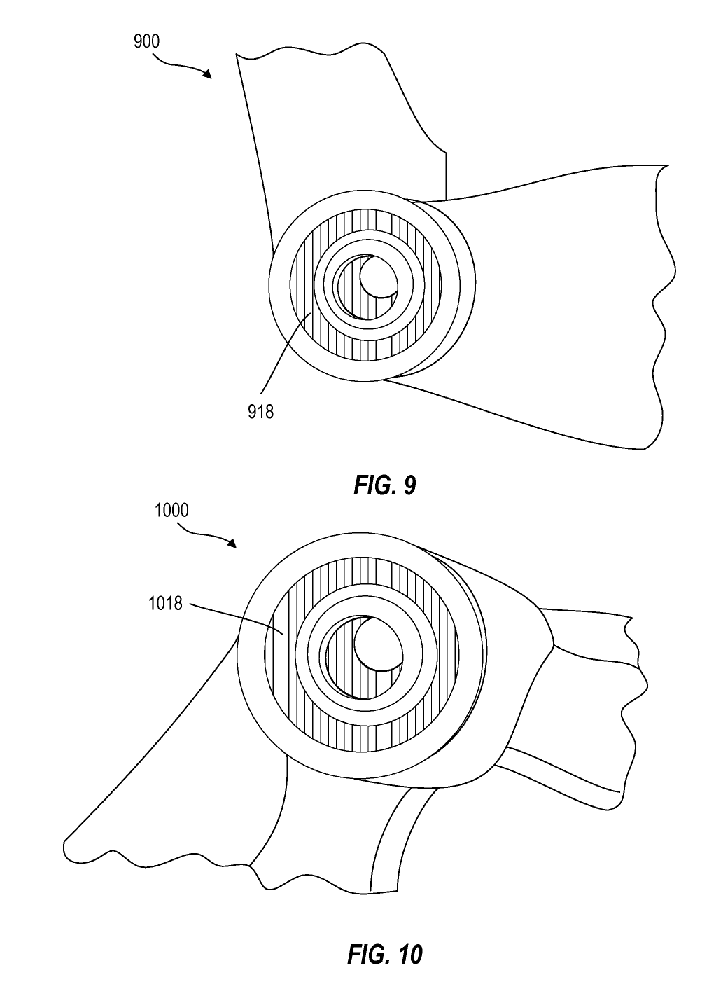

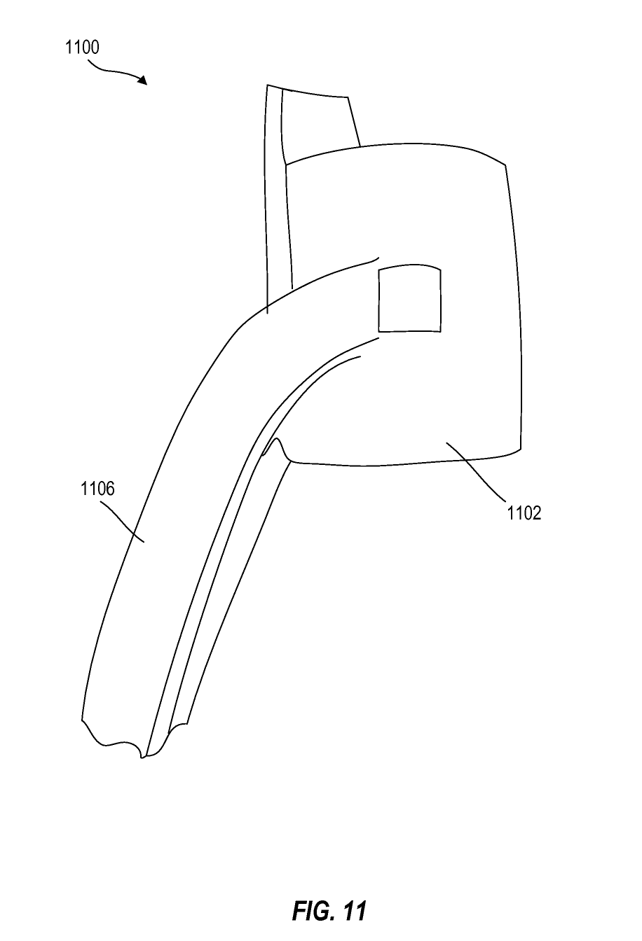

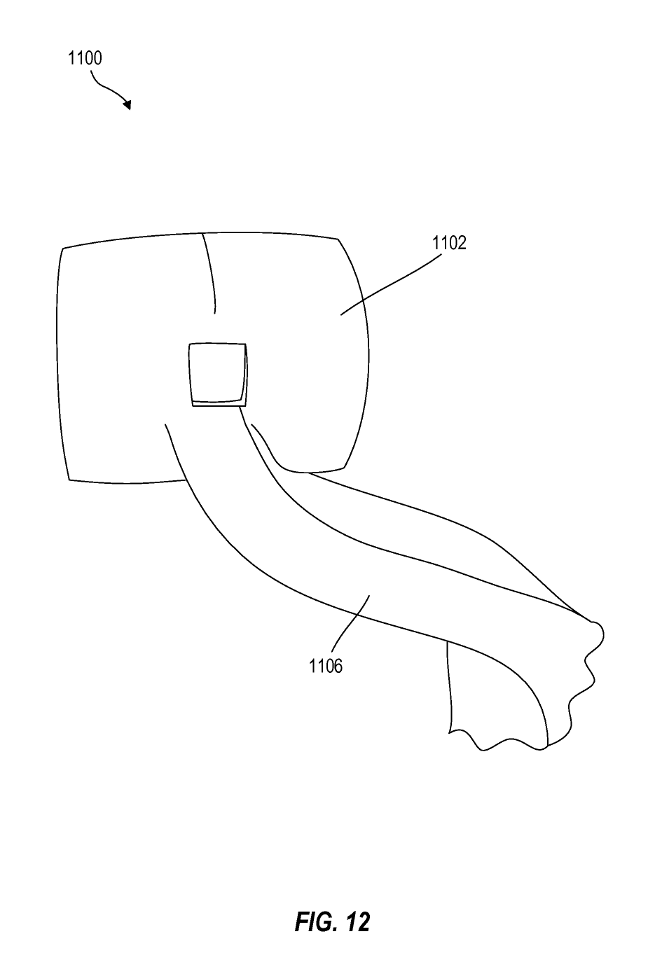

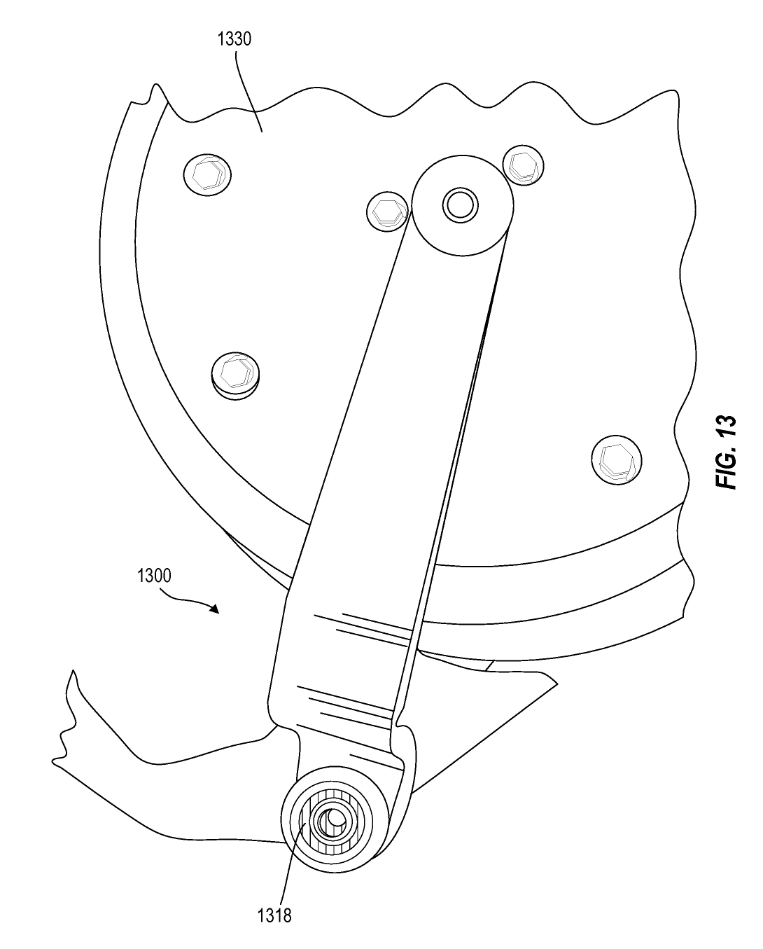

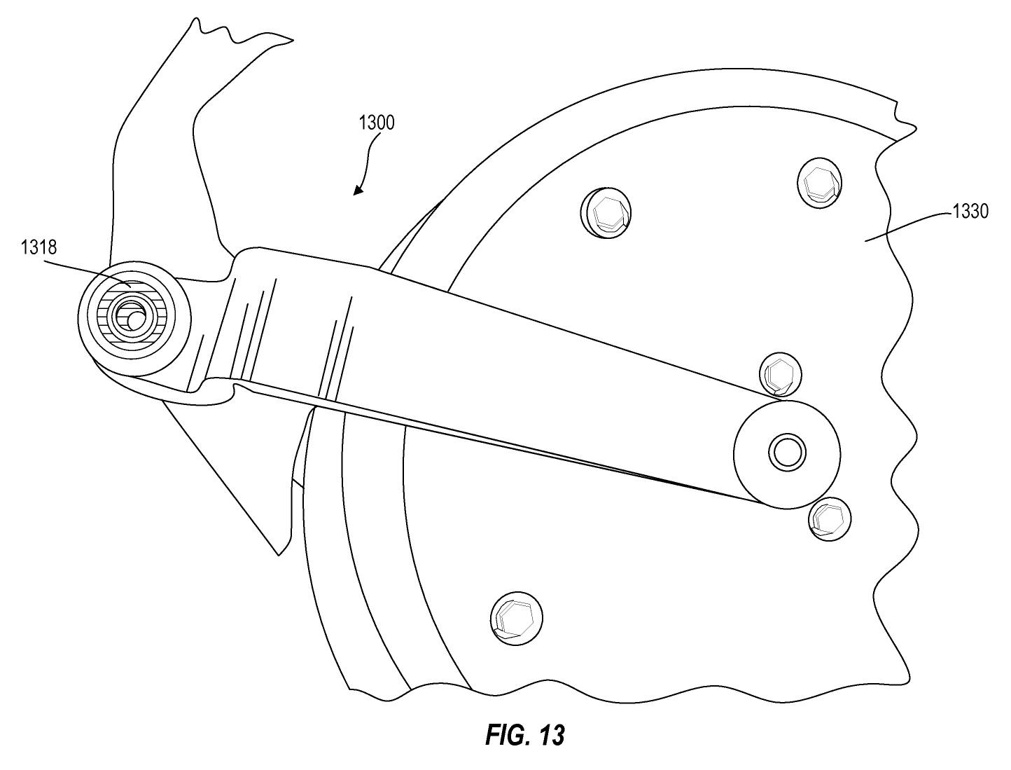

FIGS. 8-13 show additional exemplary improved wheel gauge arms containing a sealed bearing in a hub. FIG. 8 shows an exemplary wheel gauge arm 800 including a sealed bearing 818 and a shaft 806, which are examples of bearing 118 and shaft 106 of FIG. 1, respectively. FIGS. 9 and 10 each illustrate exemplary wheel gauge arms 900, 1000 including sealed bearings 918, 1018 in hubs, which are examples of bearing 118 of FIG. 1. FIGS. 11 and 12 are different perspective views of an exemplary wheel gauge arm 1100 showing a cylindrical hub 1102 extending from a shaft 1106. Wheel gauge arm 1100 is an example of wheel gauge arm 800 of FIG. 8. FIG. 13 shows an exemplary wheel gauge arm 1300 with a sealed bearing 1318 attached to a gauge wheel 1330, which regulates depth of planted seeds.

Features described above as well as those claimed below may be combined in various ways without departing from the scope hereof. The following examples illustrate some possible, non-limiting combinations:

(A1) An improved gauge wheel arm may include first and second hubs extending from either end of a shaft, with each hub forming a cylindrical body between a first face and a second face, and the first hub having a central channel through the cylindrical body. The improved gauge wheel arm may further include a bearing press-fit within the central channel, and a retaining ring fitted over the bearing, with an interior groove of the central channel proximate the first face, to retain the bearing within the central channel.

(A2) The improved gauge wheel arm denoted as (A1), the second face may form a circumferential lip about the central channel, wherein a diameter of the central channel is greater than a diameter of an opening formed by the lip.

(A3) The improved gauge wheel arm denoted as (A1) or (A2) may further include a bushing fitted within the central channel and proximate the circumferential lip.

(A4) The improved gauge wheel arm denoted as (A1) through (A3), the bearing may be a sealed bearing.

(A5) The improved gauge wheel arm denoted as (A1) through (A4), the cylindrical hub may have an inner width of about 1¼ to 1¾ inches and an outer width of about 2 to 2¼ inches.

(A6) The improved gauge wheel arm denoted as (A1) through (A5), the cylindrical hub may have a circumferential outer wall width of about ½ inch.

(B1) A gauge wheel arm may include a cylindrical hub extending from one end of the arm, the cylindrical hub having a first face, a second face, and a central channel therethrough, wherein the second face forms a lip around the circumference of the central channel, thereby providing an opening of smaller diameter than the central channel diameter. The gauge wheel arm may further include a sealed bearing press-fit inside the central channel, wherein the sealed bearing is held in place against the lip of the second face, and a retaining ring configured to retain the sealed bearing inside the first face, thereby securing the sealed bearing within the central channel.

(B2) The gauge wheel arm denoted as (B1) may further include a bushing fitted within the central channel and proximate the lip.

(B3) The gauge wheel arm denoted as (B1) or (B2), the cylindrical hub may have an inner width of about 1¼ to 1¾ inches and an outer width of about 2 to 2¼ inches.

(B4) The gauge wheel arm denoted as (B1) through (B3), the cylindrical hub may have a circumferential outer wall width of about 0.6 inch.

WHILE THE PRESENT INVENTION HAS BEEN DESCRIBED ABOVE, IT SHOULD BE CLEAR THAT MANY CHANGES AND MODIFICATIONS MAY BE MADE TO THE PROCESS AND PRODUCT WITHOUT DEPARTING FROM THE SPIRIT AND SCOPE OF THIS INVENTION.

What is claimed is:

1. An improved gauge wheel arm, comprising:
first and second hubs extending from either end of a shaft; each hub forming a cylindrical body between a first face and a second face; the first hub having a central channel through the cylindrical body;
a bearing press-fit within the central channel; and
a retaining ring fitted over the bearing, with an interior groove of the central channel proximate the first face, to retain the bearing within the central channel.

2. The gauge wheel arm of claim 1, the second face forming a circumferential lip about the central channel; wherein a diameter of the central channel is greater than a diameter of an opening formed by the lip.

3. The gauge wheel arm of claim 2, further comprising a bushing fitted within the central channel and proximate the circumferential lip.

4. The gauge wheel arm of claim 1, the bearing being a sealed bearing.

5. The gauge wheel arm of claim 1, the cylindrical hub having an inner width of about 1¼ to 1¾ inches and an outer width of about 2 to 2¼ inches.

6. The gauge wheel arm of claim 1, the cylindrical hub having a circumferential outer wall width of about ½ inch.

7. A gauge wheel arm, comprising:
a cylindrical hub extending from one end of the arm, the cylindrical hub having a first face, a second face, and a central channel therethrough, wherein the second face forms a lip around the circumference of the central channel, thereby providing an opening of smaller diameter than the central channel diameter;
a sealed bearing press-fit inside the central channel, wherein the sealed bearing is held in place against the lip of the second face; and
a retaining ring configured to retain the sealed bearing inside the first face, thereby securing the sealed bearing within the central channel.

8. The gauge wheel arm of claim 7, further comprising a bushing fitted within the central channel and proximate the lip.

9. The gauge wheel arm of claim 7, the cylindrical hub having an inner width of about 1¼ to 1¾ inches and an outer width of about 2 to 2¼ inches.

10. The gauge wheel arm of claim 7, the cylindrical hub having a circumferential outer wall width of about 0.6 inch.
